(19) United States
(12) Patent Application Publication
(10) Pub. No.: US 2022/0231855 A1
(43) Pub. Date: Jul. 21, 2022

(54) METHOD AND DEVICE FOR MANAGING DATA ASSOCIATED WITH AT LEAST ONE TECHNICAL PRODUCT

(71) Applicant: Robert Bosch GmbH, Stuttgart (DE)

(72) Inventors: Daniel Kunz, Erdmannhausen (DE); Fredrik Kamphuis, Kalkar (DE); Moritz Kornmeier, Remseck Am Neckar (DE)

(21) Appl. No.: 17/648,372

(22) Filed: Jan. 19, 2022

(30) Foreign Application Priority Data
Jan. 20, 2021 (DE) 10 2021 200 491.1

(51) Int. Cl. H04L 9/32; G06Q 20/38; G06Q 20/06

(52) U.S. Cl. CPC H04L 9/3236; H04L 9/3247; H04L 2209/46; G06Q 20/06; G06Q 20/3825

(57) ABSTRACT

A method, in particular, a computer-implemented method, for managing data associated with a product pool including at least two technical products, in particular, machines or vehicles, using a multiparty computation (MPC) process. The method includes the following steps: receiving first input data at at least one first MPC node, the first input data including operating data of the at least one first product, and receiving second input data at an at least one second MPC node, the second input data including operating data of the at least one second product, receiving further input data at one further MPC node, the further input data including the data associated with the product pool, calculating a distribution function based on the first input data, on the second input data and on the further input data, and outputting the distribution function.

### CROSS REFERENCE

The present application claims the benefit under 35 U.S.C. § 119 of German Patent Application No. DE 10 2021 200 491.1 filed on Jan. 20, 2021, which is expressly incorporated herein by reference in its entirety.

### FIELD

The present invention relates to a method, in particular, to a computer-implemented method, for managing data associated with a product pool, including at least two technical products, in particular, machines or vehicles.

The present invention further relates to a network for managing data associated with a product pool, including at least two technical products, in particular, machines or vehicles.

The present invention further relates to a technical product, in particular, to a machine or a vehicle.

The present invention further relates to a system including a product pool, including at least two technical products, in particular, machines or vehicles, and including at least one network.

### SUMMARY

Preferred specific embodiments of the present invention relate to a method, in particular, to a computer-implemented method, for managing data associated with a product pool, including at least two technical products, in particular, machines or vehicles, using a multiparty computation (MPC) process, which includes the following steps:

receiving first input data at an at least one first MPC node, the first input data including operating data of the at least one first product, and receiving second input data at an at least one second MPC node, the second input data including operating data of the at least one second product,

receiving further input data at one further MPC node, the further input data including the data associated with the product pool,

calculating a distribution function based on the first input data, on the second input data and on the further input data, and

outputting the distribution function.

In further preferred specific embodiments of the present invention, a technical product may, for example, be a machine and/or a device, for example, a power machine or work machine. In further preferred specific embodiments, a technical product may, in general, also be an arbitrary type of investment good.

In further preferred specific embodiments of the present invention, a technical product may, for example, be a vehicle, in particular, a land vehicle and/or a water craft and/or an aircraft and/or a spacecraft.

In further specific embodiments of the present invention, the operating data characterize an operation, in particular, performance data, and/or a state and/or a use (or wear, for example, also of wear-prone components) of the product.

To securely store data and/or to securely carry out calculation operations using data, a secure calculation method, namely, secure multiparty computation (MPC), is used.

By using the MPC process, it is possible to keep the input data secret. The MPC nodes receive the input data as multiple cryptographically secured shares, so-called secret shares. This ensures that no MPC node is able to learn the input data based on the cryptographically secured shares. Alternatively, a respective MPC node receives input data and distributes these in the form of cryptographically secured shares further to the remaining MPC nodes. The respective input data are then known in each case only at the respective MPC node that receives these input data. The distribution function is calculated in both cases based on the cryptographically secured shares, the result of the calculation in turn being generated as multiple shares. The shares are then in turn combined to form the result, while the input data remain secret in the process. An MPC protocol allows the parties, in this case the MPC nodes, to calculate arbitrary functions in a secure and distributed manner. MPC protocols are described, for example, in A. C. Yao, “Protocols for secure computations,” 23^{rd} Annual Symposium on Foundations of Computer Science (sfcs 1982), Chicago, Ill., USA, 1982, pp. 160-164, doi: 10.1109/SFCS.1982.38.

According to one further specific embodiment of the present invention, it is provided that the operating data and/or the data associated with the product pool are cryptographically secured. Thus, the data integrity may be advantageously ensured and an, in particular, unauthorized modification or manipulation of the data may thus be prevented.

According to one further specific embodiment of the present invention, it is provided that the securing takes place using signatures or hash trees.

According to one further specific embodiment of the present invention, it is provided that the operating data and/or the data associated with the product pool are encrypted. The encryption takes place, for example, based on an, in particular private, key assigned to a respective product.

According to one further specific embodiment of the present invention, it is provided that steps of the method, in particular, of the MPC process, are carried out cyclically.

Further specific embodiments of the present invention relate to a network, in particular, to an MPC network, including at least one first MPC node for receiving first input data, a second MPC node for receiving second input data and a further MPC node for receiving further input data, the network being designed to carry out steps of the method according to the specific embodiments.

In further preferred specific embodiments of the present invention, the network includes an output interface for outputting the distribution function to an external unit.

Further specific embodiments of the present invention relate to a technical product, in particular, to a machine or to a vehicle, the product being designed to ascertain operating data and to transfer them to a network, in particular, to a network according to the specific embodiments, in particular, to an MPC node of the network, the network being designed for managing data associated with a product pool, including at least two technical products, in particular, machines or vehicles, using a multiparty computation (MPC) process, the product being designed, in particular, to carry out the ascertainment and/or the transfer repeatedly, in particular, periodically, the product being designed, in particular, to encrypt and/or cryptographically secure at least a portion of the operating data, in particular, prior to the transfer. The securing takes place, for example using signatures or hash trees. The encryption takes place, for example, based on an, in particular private, key assigned to a respective product.

Further specific embodiments of the present invention relate to a system including a product pool, including at least two technical products, in particular machines or vehicles, in particular according to the specific embodiments and including at least one network according to the specific embodiments, the system being designed to carry out steps of a method according to the specific embodiments.

According to one further specific embodiment of the present invention, it is provided that at least one interface to a market and/or to a trading platform or exchange is provided. The interface is provided, in particular, by or at an MPC node.

Further specific embodiments of the present invention relate to a computer program, including commands which, when the program is executed by a computer, prompt the computer to carry out steps of the method according to the specific embodiments. The computer program includes, in particular, steps for calculating the distribution function.

Further specific embodiments of the present invention relate to the use of a method according to the specific embodiments and/or of a network according to the specific embodiments and/or of a technical product according to the specific embodiments and/or of the system according to the specific embodiments and/or of the computer program according to the specific embodiments for at least one of the following elements:

a) ascertaining and/or transferring, in particular, encrypted and/or cryptographically secured operating data from the at least two products of the product pool, preferably from multiple products, in particular, from a plurality of products, which may be located, in particular, at different locations and/or in different regions,

b) receiving the operating data and data associated with the product pool, in particular, investment data, as input data at a respective MPC node,

c) calculating a distribution function based on the operating data received as input data and on the data associated with the product pool,

d) outputting the distribution function, in particular, to a payout component.

The method may be used, in particular, in order to implement financing measures for investment goods in the form of technical products to be financed.

For this purpose, assets, in particular, in the form of shares of the physical entity, the technical product, are acquired. In the case of external financing, these assets may be financed by, among other things, leasing models. Normally, in such case, the financing is repaid stepwise in the form of disbursements.

In the case of a performance-related disbursement, the described method may be used to prevent operating data, in particular, meta-information, in particular, sensitive corporate information associated with the operating data from being divulged. If the divulgement is not prevented, conclusions could be drawn regarding the financial situation of an investor, for example, on the basis of the machine utilization capacity.

The data associated with the product pool are, for example, investment data, which characterize, in particular, assets or, in general, a share or part, for example, a share of the product pool.

The data associated with the product pool are transferred, for example, from a market and/or from a trading platform or from an exchange to the further MPC nodes.

Because the investment data are coupled to a product pool including multiple products and not only to one technical product, it is possible to deduce the data of one single product based on the disbursement. Investments of this type in a product pool mean that an investment is made in an industry or in a product line instead of in a single product.

The MPC network including the MPC nodes assumes the central function of the calculation of the disbursement. The disbursement is calculated based on the following values:
operating data, in particular, performance data, ideally cryptographically secured or encrypted,
investment data, in particular, the instantaneous distribution of the financial assets in the form of shares.

The operating data and the investment data are transferred as input data in the form of multiple cryptographically secured shares, so-called secret shares, to a respective MPC node. Alternatively, a respective MPC node receives the operating data and investment data as input data and distributes these in the form of cryptographically secured shares to the remaining MPC nodes. The distribution function is then calculated in both cases based on the cryptographically secured shares, the result of the calculation in turn being generated as multiple shares. The shares are then in turn combined to form the result. Thus, all participating MPC nodes, which contribute their input data and together calculate the distribution function based on these input data, are necessary for the calculation of the disbursement in the form of the distribution function.

The result, the distribution function, is transferred to a payout component, for example, with the aid of an interface. Based on the distribution function, the payout component is able to determine the amount of a respective payment to a respective investor and to carry out the payment.

With the aid of the mechanism in accordance with the present invention, manipulations of data are prevented on the one hand, and the requirements of data protection of the data, in particular, from product carriers and/or investors are ensured on the other hand. Thus, a constellation is present, in which a secure calculation including various inputs may be performed between various parties having different interests without, however, divulging the inputs.

Further features, possible applications and advantages of the present invention result from the following description of exemplary embodiments of the present invention, which are represented in the figures. All described or represented features in this case form, alone or in arbitrary combination, the subject matter of the present invention, regardless of their wording or representation in the description herein or in the figures.

### BRIEF DESCRIPTION OF THE DRAWING

FIG. 1 schematically shows a simplified block diagram according to preferred specific embodiments of the present invention.

FIG. 2 schematically shows a simplified flowchart of a method according to further preferred specific embodiments of the present invention.

### DETAILED DESCRIPTION OF EXAMPLE EMBODIMENTS

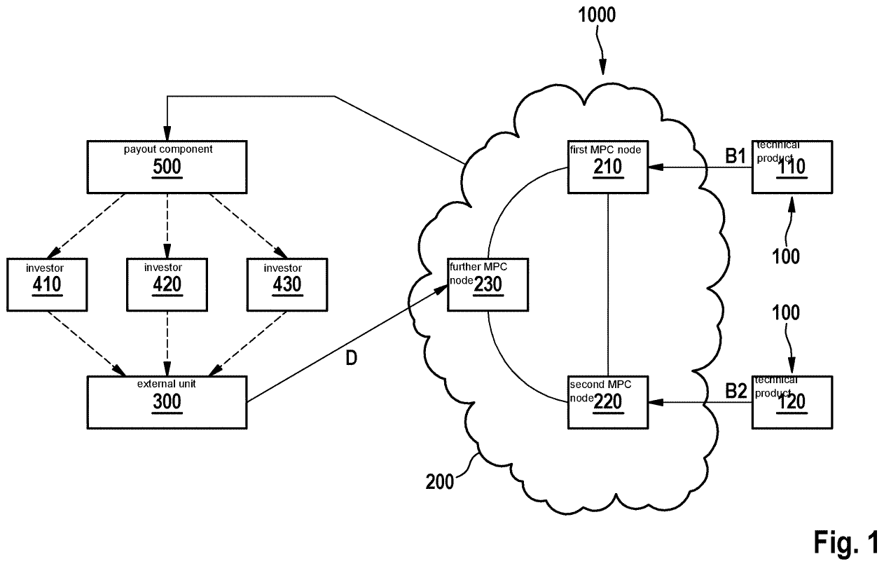

FIG. 1 schematically shows a simplified block diagram according to preferred specific embodiments of the present invention. A system 1000 including a product pool 100 and a network 200 are depicted.

Product pool 100 according to the specific embodiment represented includes two technical products 110, 120. Alternatively, it may also be provided that product pool 100 includes multiple technical products 110, 120, in particular, a plurality of technical products 110, 120. Technical products 110, 120 in this case may be located at different locations and, if necessary, in different regions.

A technical product 110, 120 is, for example, a machine and/or a device, for example, a power machine or work machine. In further preferred specific embodiments, a technical product 110, 120 may, in general, also be an arbitrary type of investment goods.

Alternatively, a technical product 110, 120 may, for example, be a vehicle, in particular, a land vehicle and/or a watercraft and/or an aircraft and/or a spacecraft.

Technical products 110, 120 are designed to ascertain operating data B1, B2 and to transfer these to network 200. The operating data are advantageously encrypted and/or cryptographically secured.

The safeguarding takes place, for example, using signatures or hash trees. The encryption takes place, for example, based on an, in particular private, key assigned to respective product 110, 120. Products 110, 120 are designed, in particular, to carry out the encryption and/or the safeguarding.

Network 200 is an MPC network. Network 200 includes a first MPC node 210 for receiving first input data and a second MPC code 220 for receiving second input data. MPC nodes 210, 220 advantageously include a communication interface, in particular, for receiving the data from technical products 110, 120, and for communicating among one another.

The first input data include operating data B1 of first technical product 110.

The second input data include operating data B2 of second technical product 120.

According to the specific embodiment represented herein, network 200 includes a further MPC node 230 for receiving further input data.

The further input data according to the specific embodiment represented are data D associated with product pool 100. The data associated with the product pool are, for example, investment data, which characterize, in particular, assets or, in general, a share or part, for example, a share of the product pool.

Data D associated with the product pool according to the specific embodiment represented, are transferred from an external unit 300, for example, from a market and/or from a trading platform and/or from an exchange to further MPC nodes 230.

Data D associated with the product pool are advantageously also transferred in an encrypted and/or cryptographically secured manner.

Three further entities 410, 420, 430 are also represented in FIG. 1. Entities 410, 420, 430 are, for example, investors, who have each acquired a share of product pool 100 via external unit 300.

Network 200 according to the specific embodiment represented is designed to calculate a distribution function using an MPC process. For this purpose, MPC nodes 210, 220, 230 advantageously include one processing unit each.

By using the MPC process, it is possible to keep the input data secret. MPC nodes 210, 220, 230 receive the input data as multiple cryptographically secured shares, so-called secret shares. Alternatively, a respective MPC node 210, 220, 230 receives the input data and distributes these in the form of the cryptographically secured shares further to remaining MPC nodes 210, 220, 230. The respective input data are then known, in each case only to respective MPC node 210, 220, 230 that receives these input data. The distribution function is then calculated based on the cryptographically secured shares, the result of the calculation in turn being generated as multiple shares. The shares are then combined in turn to form the result, while the input data remain secret in the process. An MPC protocol allows MPC nodes 210, 220, 230 to calculate the distribution function in a secure and distributed manner.

The calculated distribution function is then transferred to a payout component 500, in particular, via a suitable interface. Based on the distribution function, an amount of the payment to a respective investor 410, 420, 430 is determined by payout component 500 and the payment is advantageously carried out.

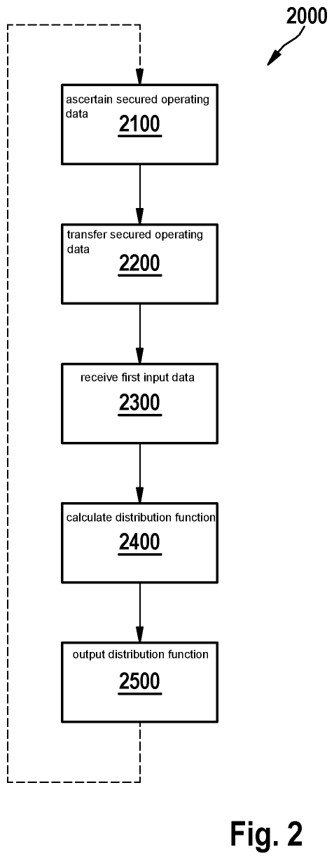

FIG. 2 shows steps of a method 2000 according to further preferred specific embodiments.

Method 2000 includes a step 2100 for ascertaining, in particular, encrypted and/or cryptographically secured operating data B1, B2 from the at least two products 110, 120 of product pool 100.

Method 2000 further includes a step 2200 for transferring, in particular, encrypted and/or cryptographically secured operating data B1, B2 from the at least two products 110, 120 of product pool 100 to MPC nodes 210, 220 of network 200.

Method 2000 further includes a step 2300 for receiving first input data at first MPC node 210, the first input data including operating data B1 of first product 110, and receiving 2300 second input data B2 at second MPC node 220, the second input data including operating data B2 of second product 120, and receiving 2300 further input data at third MPC node 230, the further input data including data D associated with product pool 100.

Method 2000 further includes a step 2400 for calculating the distribution function based on the first input data, on the second input data and on the further input data.

Method 2000 further includes a step 2500 for outputting the distribution function, in particular, to payout component 500. All steps of method 2000 are advantageously carried out repeatedly, in particular, periodically, and/or at predefinable points in time.

What is claimed is:

1. A computer-implemented method for managing data associated with a product pool including at least two technical products, using a multiparty computation (MPC) process, the method comprising the following steps:
receiving first input data at at least one first MPC node, the first input data including operating data of the at least one first product of the at least two technical products, and receiving second input data at at least one second MPC node, the second input data including operating data of at least one second product of the at least two technical products;
receiving further input data at one further MPC node, the further input data including the data associated with the product pool;
calculating a distribution function based on the first input data, on the second input data, and on the further input data; and
outputting the distribution function.

2. The method as recited in claim 1, wherein the at least two technical products include machines or vehicles.

3. The method as recited in claim 1, wherein: (i) the operating data of the at least one first product and the at least one second product and/or (ii) the data associated with the product pool, are cryptographically secured.

4. The method as recited in claim 3, wherein the securing takes place using signatures or hash trees.

5. The method as recited in claim 1, wherein: (i) the operating data of the at least one first product and the at least one second product and/or (ii) the data associated with the product pool, are encrypted.

6. The method as recited in claim 1, wherein steps of the MPC process are carried out cyclically.

7. A multiparty computation (MPC) network, comprising:
at least one first MPC node configured to receive first input data;
at least one second MPC node configured to receive second input data; and
at least one further MPC node configured to receive further input data;
wherein the network is configured to manage data associated with a product pool including at least two technical products, using an MPC process, the network configured to:
receive first input data at the at least one first MPC node, the first input data including operating data of at least one first product of the at least two technical products, and receive second input data at the at least one second MPC node, the second input data including operating data of at least one second product of the at least two technical products;
receive further input data at the at least one further MPC node, the further input data including the data associated with the product pool;
calculate a distribution function based on the first input data, on the second input data, and on the further input data; and
output the distribution function.

8. A technical product, the product being configured to ascertain operating data and to transfer the operating data to a first multiparty computation (MPC) node of an MPC network, the network configured to manage data associated with a product pool including at least two technical products including the product, using an MPC process, the product being configured to ascertain operating data and/or transfer the operating data periodically, the product being configured to encrypt and/or cryptographically secure at least a portion of the operating data prior to the transfer, the MPC network including:
the least one first MPC node configured to receive first input data;
at least one second MPC node configured to receive second input data; and
at least one further MPC node configured to receive further input data;
wherein the network is configured to manage data associated with a product pool including at least two technical products, using an MPC process, the network configured to:
receive first input data at the at least one first MPC node, the first input data including operating data of the product, and receive second input data at the at least one second MPC node, the second input data including operating data of at least one second product of the at least two technical products;
receive further input data at the at least one further MPC node, the further input data including the data associated with the product pool;
calculate a distribution function based on the first input data, on the second input data, and on the further input data; and
output the distribution function.

9. The technical product as recited in claim 8, wherein the technical product is a machine or a vehicle.

10. A system comprising:
at least two technical products; and
a multiparty computation (MPC) network, including:
at least one first MPC node configured to receive first input data;
at least one second MPC node configured to receive second input data; and
at least one further MPC node configured to receive further input data;
wherein the network is configured to manage data associated with a product pool including the at least two technical products, using an MPC communication process, the network configured to:
receive first input data at the at least one first MPC node, the first input data including operating data of at least one first product of the at least two technical products, and receive second input data at the at least one second MPC node, the second input data including operating data of at least one second product of the at least two technical products;
receive further input data at the at least one further MPC node, the further input data including the data associated with the product pool;
calculate a distribution function based on the first input data, on the second input data, and on the further input data; and
output the distribution function.

11. The system as recited in claim 10, wherein the at least two technical products include machines or vehicles.

12. The system as recited in claim 10, further comprising:
at least one interface to a market and/or to a trading platform and/or or to an exchange.

13. A non-transitory computer-readable medium on which is stored a computer program including commands for managing data associated with a product pool including at least two technical products, using a multiparty computation (MPC) process, the commands, when executed by a computer, causing the computer to perform the following steps:
receiving first input data at at least one first MPC node, the first input data including operating data of the at least one first product of the at least two technical products, and receiving second input data at at least one second MPC node, the second input data including operating data of at least one second product of the at least two technical products;
receiving further input data at one further MPC node, the further input data including the data associated with the product pool;
calculating a distribution function based on the first input data, on the second input data, and on the further input data; and
outputting the distribution function.

14. A method for managing data associated with a product pool including at least two technical products using a multiparty computation (MPC) process, the method comprising the following steps:
a) ascertaining and/or transferring encrypted and/or cryptographically secured operating data from the at least two products of the product pool;
b) receiving the operating data of each of the at least two products as input data and data associated with the product pool, at a different respective MPC node, wherein the data associated with the product pool are investment data;
c) calculating a distribution function based on the operating data received as the input data and on the data associated with the product pool; and
d) outputting the distribution function to a payout component.

15. The method as recited in claim 14, wherein the at least two technical products include machines or vehicles.

16. The method as recited in claim 14, wherein each of the at least two technical products are at different locations.
